(19) United States
(12) Patent Application Publication
(10) Pub. No.: US 2004/0241406 A1
(43) Pub. Date: Dec. 2, 2004

(54) Glazing provided with stacked thin layers reflecting infrared rays and/or solar radiation

(75) Inventors: Nicolas Nadaud, Gentilly (FR); Ulrich Billert, Aachen (DE); Juergen Schutt, Aachen (DE); Li-Ming Yu, Namur (BE)

Correspondence Address: OBLON, SPIVAK, MCCLELLAND, MAIER & NEUSTADT, P.C., 1940 DUKE STREET, ALEXANDRIA, VA, 22314, US

(73) Assignee: Saint-Gobain Glass France, Courbevoie (FR)

(21) Appl. No.: 10/483,989

(22) PCT Filed: Jul. 25, 2002
(86) PCT No.: PCT/FR02/02674

(30) Foreign Application Priority Data
Jul. 25, 2001 (FR) 01 09900

(51) Int. Cl. B32B 7/02

(52) U.S. Cl. 428/212

(57) ABSTRACT

The invention relates to glazing that comprises at least one transparent substrate S provided with a stack of thin layers comprising an alternation of n functional layers A having reflection properties in the infrared and/or in solar radiation, especially metal layers, and (n+1) coatings B made of a dielectric, where n≧1. The stack satisfies the following criteria: at least one functional layer A is (i) directly in contact with the dielectric coating B placed on top of it and (ii) in contact with the dielectric B placed beneath it via a layer C that absorbs at least in the visible, of the metallic, optionally nitride, type.

The invention relates to transparent substrates, preferably rigid ones of the glass type, which are provided with stacks of thin layers comprising at least one layer exhibiting metallic behavior that can act on solar radiation and/or infrared radiation of long wavelength for the purpose of forming glazing.

The invention deals with alternating stacks of silver-based layers and layers made of a dielectric of the metal oxide or silicon nitride type, making it possible to give the glazing solar-protection or low-emissivity properties (double glazing for buildings, laminated windshields for vehicles, etc.). It relates more particularly to glass substrates that are provided with such stacks and must undergo conversion operations involving a heat treatment at at least 500° C.: this may in particular be a toughening, annealing or bending operation.

Rather than deposit the layers on the glass after its heat treatment (which poses substantial technological problems), it has been sought firstly to adapt the multilayer stacks so that they can undergo such treatments while preserving most of their thermal properties. The object was therefore to prevent deterioration of the functional layers, especially the silver layers. One solution, disclosed in patent EP-506 507, consists in protecting the silver layers by flanking them with metal layers, which will protect the silver layers. A stack that can be bent or toughened is therefore obtained, insofar as it is as effective in reflecting infrared or solar radiation after bending or toughening as it was beforehand. However, oxidizing/modifying the layers that have protected the silver layers from the effect of heat result in the optical properties of the stack being substantially modified, especially by increasing the light transmission and modifying the colorimetric response in reflection. Furthermore, this heating also tends to create optical defects, namely pinholes and/or various small impairments resulting in a significant level of haze (the expression “small impairments” is generally understood to mean defects having a size of less than 5 microns, whereas “pinholes” is understood to mean defects having a size of more than 50 microns, especially between 50 and 100 microns, with, of course, the possibility of also having defects of intermediate size, that is to say between 5 and 50 microns).

Secondly, it has therefore been endeavored to develop such stacks of thin layers which are capable of retaining both their thermal properties and their optical properties after heat treatment, by minimizing any appearance of optical defects. The challenge is thus to have stacks of thin layers of constant optical/thermal performance, whether or not they have to undergo heat treatment.

A first solution was proposed in patent EP-718 250. This solution recommended the use on top of the silver-based functional layer or layers of oxygen diffusion barrier layers, especially those based on silicon nitride, and the direct deposition of the silver layers on the subjacent dielectric coating without the inter-position of primer layers or metal protective layers.

It proposed stacks of the type:

Si₃N₄/ZnO/Ag/Nb/ZnO/Si₃N₄

or

SnO₂/ZnO/Ag/Nb/Si₃N₄.

A second solution was proposed in patent EP-847 965: this solution was more directed toward stacks comprising two silver layers and discloses the use both of a barrier layer on top of the silver layers (as previously) and of an absorbent or stabilizing layer adjacent to said silver layers and allowing them to be stabilized.

It disclosed stacks of the type:

SnO₂/ZnO/Ag/Nb/Si₃N₄/ZnO/Ag/Nb/WO₃ or ZnO or SnO₂/Si₃N₄.

In both solutions, the presence of the metal layer, in this case made of niobium, on the silver layers should be noted, which prevents the silver layers from being in contact with an oxidizing or nitriding reactive atmosphere during deposition by reactive sputtering of the ZnO layer or of the Si₃N₄ layer, respectively.

These solutions are in most cases satisfactory. However, there is an increasing need to have glasses with very pronounced curvatures and/or of complex shape (double curvature, S-shaped curvature, etc.). This is most particularly the case with glasses used for automobile windshields or shop windows. In this case, the glasses are subjected to locally differentiated treatments from the thermal and/or mechanical stand-point, as is especially described in the patents FR-2 599 357, U.S. Pat. No. 6,158,247, U.S. Pat. No. 4,915,722 or U.S. Pat. No. 4,764,196. This is particularly stressful for the stacks of thin layers: localized optical defects and slight variations in appearance in reflection from one point to another in the glazing may therefore appear.

It is therefore an object of the invention to overcome this drawback by endeavoring to improve the stacks of thin layers described above, especially by seeking to improve their behavior with respect to stressful heat treatments of the bending and/or toughening type. The invention aims in particular to maintain the thermal performance of the stacks and to minimize any optical modification thereof and any appearance of optical defects. Its aim is more particularly to preserve the uniformity of optical appearance of glasses coated after heat treatment, from one glass to another and/or from one region of the same glass to another, and to do so even in the case of treatment of the glazing that differs locally from one point to another. The aim is especially to limit as far as possible any optical variation of the glazing from one point to another, especially in the case of a glass that has to be bent, from a slightly or unbent region to a highly bent region.

The subject of the invention is firstly glazing that comprises at least one transparent substrate, especially made of glass, provided with a stack of thin layers comprising an alternation of n functional layers A having reflection properties in the infrared and/or in solar radiation, especially metal layers, and of n+1 coatings B, where n≧1, said coatings B comprising a layer or a superposition of layers made of a dielectric, so that each functional layer A is placed between two coatings B. The stack furthermore has the following characteristics: at least one of the functional layers A is (i) directly in contact with the dielectric coating B placed on top of it and (ii) in contact with the dielectric coating B placed beneath them via a layer C that absorbs at least in the visible, of the metallic, optionally nitride, type.

Preferably:

(i) the or each of the functional layers A is directly in contact with the dielectric coating B placed on top of it, and

(ii) the or each of the functional layers A is in contact with the dielectric coating B placed beneath them via a layer C that absorbs at least in the visible, of the metallic, optionally nitride, type.

The invention thus goes counter to what is usually considered, since it omits the “sacrificial” metal, especially silver, layer on top of the functional layers and moves said metal layer so as to place it beneath them. In fact, surprisingly it has been found that a thin metal layer beneath a functional layer greatly helps to stabilize it during the heat treatments, even the most stressful ones, and does so more effectively than in a configuration in which it is on top of the functional layers (throughout the rest of the text, no distinction will be made between Ag layer and functional layer A for the sake of brevity, bearing in mind that for the applications envisioned in the invention silver layers are the most usual, but the invention applies in the same way to other reflecting layers made of metal, such as silver alloys, especially those containing titanium or palladium, or gold-based alloys).

It is in fact possible when manufacturing the stack to prevent the Ag from deteriorating during deposition of the next, oxide or nitride, layer by reactive sputtering. Various options will be detailed below. Furthermore, the presence of this “sacrificial” layer during heat treatment of the stack tends to cause more haze than in a configuration in which it is beneath the functional layers. It tends in fact to lower the optical quality of the stack after heat treatment.

This particular configuration of Ag layers has made it possible to eliminate most of the optical defects, especially a veil-type defect, on the stack of thin layers after heat treatment.

Advantageously, the thickness of the absorbent layer or layers C is less than or equal to 1 nm, especially less than or equal to 0.7 or 0.6 or 0.5 nm. For example, it is about 0.2 to 0.5 nm. The term “layer” is therefore to be taken in the broad sense. This is because it is possible for the layers, if they are thin, not to be continuous—they also form islands on the subjacent layer.

This extreme thinness has several advantages: the layer may fulfil its role as a “trap” for aggressive species that attack the material of the functional layer A, in this case silver, during the heat treatments. On the other hand, it only has a very slight negative effect on the stack in terms of loss of light transmission and it is quickly deposited by sputtering. Perhaps more importantly, as the case may be, its thinness means that it does not “interfere” (or only very slightly) with the interaction between the Ag layer and the layer lying beneath this absorbent layer.

Although this subjacent layer has a “wetting” effect with respect to the Ag layer (for example when the subjacent layer is based on zinc oxide, as will be explained in detail layer), it will be able to preserve this advantageous effect despite the presence of the absorbent intermediate layer.

The subject of the invention is also said substrate, especially made of glass, comprising at least two functional layers A alternating with coatings B as explained above (in this case, n≧2). The stack also includes layers C that absorb at least in the visible, the total thickness of these layers C being less than or equal to 2.5 nm, especially less than or equal to 2 or to 1.8 or to 1.4 nm. Preferably, these layers C are placed between the functional layers A and the coatings B which lie beneath them. These layers are especially metallic, optionally nitride, layers.

In a configuration having several absorbent layers C, it is preferable for the layer C furthest away from the substrate to be thicker than the other layers. There may be a graduation in the thicknesses of the layers C—the further away they are from their carrier substrate, the thicker they are. This may be justified by the fact that the final absorbent layer C can thus help to protect the functional layers A that were deposited before them. In a stack with two layers C and two layers A, it is thus possible to have a thickness ratio, between the second absorbent layer and the first absorbent layer, in the region of ⅔ to ⅓ (for example 75/25 to 55/45 in terms of percentage thickness).

The absorbent layer or layers C according to the invention are preferably based on titanium Ti, nickel Ni, chromium Cr, niobium Nb, zirconium Zr or a metal alloy containing at least one of these metals: titanium has proved to be particularly appropriate.

Advantageously, at least one (in particular each) of the coatings B lying directly on top of a functional layer A starts with a layer D based on one or more metal oxides. This amounts to saying that there is direct contact between the or each of the functional layers and the metal oxide layer(s) lying on top of it (or at least in the case of one of the functional layers).

This oxide layer may fulfil the stabilizing function mentioned in the abovementioned patent EP-847 965. It may allow the silver to be stabilized, in particular in the case of heat treatment. It also tends to promote the adhesion of the entire stack. Preferably, it is a layer based on zinc oxide or on a mixed oxide of zinc and another metal (of the Al type). There may also be oxides comprising at least one of the following metals: Al, Ti, Sn, Zr, Nb, W, Ta. An example of a mixed zinc oxide that can be deposited as a thin layer according to the invention is a mixed zinc-tin oxide containing an additional element such as an antimony, as described in WO 00/24686.

When all of the layers are deposited by sputtering, precautions need to be taken so that deposition of the oxide layer does not damage the subjacent Ag layer. In fact, it is preferable for the oxide to be deposited so as to be (slightly) substoichiometric in oxygen, while still remaining below the threshold, beneath which the oxide layer would become absorbent in the visible. If it is ZnOx (or a mixed oxide), it is thus preferable for x to be slightly less than 1 (for example 0.88 to 0.98, especially from 0.90 to 0.95). The stoichiometry in oxygen may be controlled in various ways. It is possible to use a method of deposition using plasma monitoring called PEM (plasma emission monitoring). It is also possible to use nonreactive sputtering, using an oxide target or a ceramic target based on zinc and oxygen and possibly aluminum, for example.

This layer D is preferably of limited thickness; it is, for example, from 2 to 30 nm, especially from 5 to 10 nm.

Again advantageously, at least one (in particular each) of the coatings B lying just beneath a functional layer A terminates in a layer D′ based on one or more metal oxides. This may be the same zinc oxide or mixed oxide containing zinc as in the case of the layers D described above. However, it is unnecessary in this case for their stoichiometry in oxygen to be controlled as precisely: the layers may be stoichiometric layers. Layers containing ZnO are particularly beneficial as they have the property of thoroughly wetting the silver and of facilitating its crystalline growth insofar as ZnO and silver crystallize in a similar manner with similar lattice parameters—silver can grow in a columnar fashion on a well-crystallized layer. Crystallization of the zinc oxide is then transferred to the silver via a phenomenon known as heteroepitaxy. This crystallization transfer and this wettability between the ZnO-containing layer and the Ag layer are maintained despite the interposition of an absorbent layer C provided that the latter is thin enough (at most 1 nm). The layer D′ preferably has a thickness of between 6 and 15 nm.

To summarize, the layers C stabilize the Ag layers during heat treatments without decreasing their ability to crystallize and without inducing excessively strong light absorption, if their location and their thickness are selected appropriately. The layers D′ favor the spreading-out/crystallization of the Ag layers (which at the same time limits any post-deposition crystallization of the silver, under the effect of a heat treatment, but can result in its properties being changed) and the layers D may serve to stabilize the silver, especially preventing it from migrating in the form of islands.

To prevent the Ag layers from being damaged by high-temperature diffusion of oxygen coming from the ambient atmosphere, it is preferable to provide, at least in the (n+1)th coating B (that is to say the last one counting from the substrate), a layer capable of acting as an oxygen barrier. This is preferably a layer based on aluminum nitride and/or silicon nitride. Advantageously, all the coatings B include such a barrier layer. In this way, each of the functional layers A is flanked by two oxygen barrier layers, however these layers may possibly also be barriers to the diffusion of species migrating from the glass, especially alkali metals. Preferably, these barrier layers have a thickness of at least 5 nm, especially at least 10 nm, for example between 15 and 50 nm or between 20 and 40 nm or between 22 and 30 nm when they do not lie between two functional layers. When they do lie between two functional layers, they preferably have a substantially greater thickness, especially a thickness of at least 10 nm, especially at least 40 nm, for example between 40 and 50 or 70 nm.

In the case of a stack that includes at least two functional layers A (n≧2), it is preferable for a coating B lying between two layers A (especially the nth) to be relatively thick, for example having a thickness of around 50 to 90 nm, in particular 70 to 90 nm.

This coating B may include a diffusion barrier layer as described above with a thickness of 0 to 70 nm, or 0 to 65 nm, especially 2 to 35 nm, in particular 5 to 30 nm, if necessary combined with an oxide layer D and/or D′ of suitable thickness, especially a layer D and/or a layer D′ having a total thickness of 15 to 90 nm, in particular 35 to 90 nm, especially 35 to 88 nm, more particularly 40 to 85 nm.

One nonlimiting embodiment of the invention consists in providing a stack comprising, once or twice, the sequence:

. . . /ZnO/Ti/Ag/ZnO/ . . .

the ZnO possibly containing another metal in a minority proportion relative to Zn, of the Al type, and the ZnO on top of the Ag layer preferably being slightly substoichiometric in oxygen (at the very least before post-deposition heat treatment).

It is possible to have this sequence twice in a stack of the type:

substrate/Si₃N₄⁽¹⁾/ZnO/Ti/Ag/ZnO/Si₃N₄⁽²⁾/ZnO/Ti/Ag/ZnO/Si₃N₄^{(3),}

the Si₃N₄ possibly containing another metal or an element in a minority proportion relative to Si, such as a metal (Al) or boron and the ZnO also possibly containing a minority metal.

As a variant, the Si₃N₄ layers (1) and/or (2) may be omitted, for example by replacing them with an oxide layer (SnO₂, a mixed zinc-tin oxide, etc.) or by consequently thickening the ZnO layer that is adjacent to them.

Preferably, in this type of stack having two silver layers, the Si₃N₄-based layer between the two silver layers has, for example, a thickness of at least 50 nm, especially between 55 and 70 nm. On the opposite side to each of the silver layers, it is preferable to provide Si₃N₄-based layers having a thickness of at least 15 nm, especially between 20 and 30 nm.

With such a stack configuration, the coated substrates according to the invention may undergo treatments at more than 500° C., especially for the purpose of bending, toughening or annealing (even bending treatments that differ from one point on the substrate to another), with a change in light transmission ΔT_{L}(measured under illuminant D₆₅) between the value before bending and the value after bending of at most 5%, especially at most 4%, and/or a difference in colorimetric response in reflection ΔE*, between the value before bending and after bending, of at most 4, especially at most 3. ΔE is expressed in the following manner in the (L*, a*, b*) colorimetry system: ΔE=(ΔL*²+Δa*²+Δb*²)^{1/2}.

These ΔE and ΔT_{L} values are especially verified in the case of glazing with a laminated structure of the type: glass/thermoplastic (such as PVB) sheet/multilayer stack/glass.

Furthermore, a remarkable uniformity of appearance over the entire coated substrate is observed.

The coated substrate (glass) may then be mounted as laminated glazing by combining it in a known manner with another glass via at least one sheet of a thermoplastic polymer. Within the glazing, the stack is placed so as to be in contact with said thermoplastic sheet. It adheres satisfactorily to said sheet. It may also be mounted as what is called asymmetrical laminated glazing, by combining it with at least one sheet of polymer of the polyurethane type having energy absorption properties, possibly combined with another layer of polymer having self-healing properties (reference may be made to the patents EP-132 198, EP-131 523 and EP-389 354 for further details regarding this type of laminate). The laminated glazing obtained may be used as vehicle windshields or side windows.

In laminated glazing formed in this way, there is a small change in calorimetric response between normal incidence and non-normal incidence, typically at 60°. This calorimetric difference at non-normal incidence is expressed through the parameters a*(0°) and b*(0°), measured at an angle of incidence of 0° (normal incidence), and a*(60°) and b*(60°), measured at an angle of incidence of 60°. Note the following: Δa*_{(0→60)}=a*(60°)−a*(0°) and Δb*_{(0→60)}=b*(60°)−b*(0°). The following colorimetric changes were observed: Δa*_{(0→60)}<4 Δb*_{(0→60)}<2 for a*(60°)<0 and b*(60°)<0.

Thus, in the case of glazing for which a*(0°) is between −6 and −3.5 and b*(0°) is between −3 and 0, observation at an angle of incidence of 60° gives a small color change with a*(60°) being between −4 and 0 and b*(60°) being between −4 and 0.

The coated substrate can be used as monolithic (single) glazing or can be combined with at least one other glass via a gas-filled cavity to make insulating multiple (double) glazing. In this case, the stack preferably faces the intermediate gas-filled cavity.

As mentioned above, one particularly targeted application of the invention relates to glazing for vehicles, especially windshields and side windows. Thanks to the multilayer stack according to the invention, the windshields and side windows may have remarkable solar-protection properties. It may also serve as heated, especially de-icing, windows by providing suitable current leads and by adapting the resistance of the layers (resistance per square R), etc.

Advantageously, the substrate, once it has been provided with the stack of thin layers, undergoes a heat treatment at more than 500° C. for the purpose of bending it, with, after bending, a color in exterior reflection in the blues, in the greens or in the blue-greens.

The invention will now be described in more detail with the aid of the following nonlimiting examples.

In all the following examples, the layers were deposited by magnetic-field-enhanced sputtering on a clear soda-lime silicate glass 2.1 mm in thickness of the PLANILUX type (glass sold by Saint-Gobain Glass).

The silicon-nitride-based layers were deposited from Al-doped or B-doped Si targets in a nitriding atmosphere. The Ag-based layers were deposited from Ag targets in an inert atmosphere and the Ti-based layers were deposited from a Ti target, again in an inert atmosphere. The ZnO layers were deposited from targets made of Zn containing 1 to 4% Al by weight. Those layers lying beneath the Ag layers had a standard stoichiometry in oxygen while those deposited directly on the silver layers were slightly substoichiometric in oxygen, while remaining transparent in the visible, the stoichiometry being monitored by PEM.

### EXAMPLES 1 AND 2

These examples relate to the following stack: glass/Al:Si₃N₄/Al:ZnO/Ti/Ag/Al:ZnO₁₋ₓ/Al:Si₃N₄/Al:ZnO/Ti/Ag/Al:ZnO₁₋ₓ/Al:Si₃N₄, where Al:Si₃N₄ means that the nitride contains aluminum. The same applies to Al:ZnO. Furthermore, Al:ZnO₁₋ₓ means that the oxide is deposited so as to be slightly substoichiometric in oxygen, without being absorbent in the visible.

Table 1 below repeats the stack of layers with the thicknesses indicated in nanometers for each of the two examples.

TABLE 1

| Glass | Example 1 | Example 2 |
|---|---|---|
| Al:Si₃N₄ | 22.5 nm | 22.5 nm |
| Al:ZnO | 8 nm | 8 nm |
| Ti | 0.4 nm | 0.5 nm |
| Ag | 8.7 nm | 8.7 nm |
| Al:ZnO₁₋ₓ | 6 nm | 6 nm |
| Al:Si₃N₄ | 62 nm | 62 nm |
| Al:ZnO | 10 nm | 10 nm |
| Ti | 0.6 nm | 0.5 nm |
| Ag | 9.7 nm | 9.7 nm |
| Al:ZnO₁₋ₓ | 5 nm | 5 nm |
| Al:Si₃N₄ | 26 nm | 26 nm |

### COMPARATIVE EXAMPLES 3 AND 4

These are identical to example 1 except for the following characteristic: the Ti layers beneath the silver layers were omitted. Instead, Ti layers were added on top of each of the silver layers. Table 2 below gives the stack of layers, with thicknesses indicated in nanometers for each of the two examples:

TABLE 2

| Glass | Comp. Example 3 | Comp. Example 4 |
|---|---|---|
| Al:Si₃N₄ | 22.5 nm | 22.5 nm |
| Al:ZnO | 8 nm | 8 nm |
| Ag | 8.7 nm | 8.7 nm |
| Ti | 0.5 nm | 1 nm |
| Al:ZnO₁₋ₓ | 6 nm | 6 nm |
| Al:Si₃N₄ | 62 nm | 62 nm |
| Al:ZnO | 10 nm | 10 nm |
| Ag | 9.7 nm | 9.7 nm |
| Ti | 0.5 nm | 0.5 nm |
| Al:ZnO₁₋ₓ | 5 nm | 5 nm |
| Al:Si₃N₄ | 26 nm | 26 nm |

### COMPARATIVE EXAMPLE 5

The multilayer stack is the same as that of example 1, but the two Al:ZnO layers on top of the silver layers this time had an stoichiometry in oxygen different from that of example 1: these layers were made of Al:ZnO₁₊ₓ, this indicating that these layers (as deposited, before heat treatment) were superstoichiometric in oxygen.

### COMPARATIVE EXAMPLE 6

The stack was the same as in example 1, but the two Al:ZnO_{1-y} layers on top of the Ag layers were substantially more substoichiometric in oxygen, starting to become absorbent.

### EXAMPLE 7

The stack was the same as in example 1, but all of the Al:ZnO-based layers, therefore both the layers on the silver layers and those beneath the silver layers, were slightly substoichiometric in oxygen without being absorbent—they were all of the Al:ZnO₁₋ₓ type with the above convention.

### EXAMPLES 8 AND 9

These two examples repeat the type of sequence of layers of example 1, but all the Al:ZnO-based layers were stoichiometric in oxygen and the layers had slightly different thicknesses.

Table 3 below repeats the stack of layers with the thicknesses indicated in nanometers for each of the two examples:

TABLE 3

| Glass | Example 8 | Example 9 |
|---|---|---|
| Al:Si₃N₄ | 21.5 nm | 23 nm |
| Al:ZnO | 8 nm | 8 nm |
| Ti | 0.2 nm | 0.4 nm |
| Ag | 8.4 nm | 10.7 nm |
| Al:ZnO | 5 nm | 5 nm |
| Al:Si₃N₄ | 67.1 nm | 63.5 nm |
| Al:ZnO | 8 nm | 8 nm |
| Ti | 0.2 nm | 0.6 nm |
| Ag | 10.6 nm | 11.8 nm |
| Al:ZnO | 5 nm | 5 nm |
| Al:Si₃N₄ | 20.3 nm | 23 nm |

### EXAMPLES 8A AND 9a

These examples are identical to examples 8 and 9 respectively, except for the difference that, as in the case of example 1, the Al:ZnO₁₋ₓ-based layers on top of the silver layers were deposited so as to be slightly substoichiometric in oxygen.

All of these coated glasses underwent an overall bending operation at over 500° C., with local regions having a high curvature.

The change in appearance of the glasses from before and after heat treatment was then evaluated by measuring the change in light transmission ΔT_{L} as a percentage (average change under illuminant D₆₅) and the change in appearance ΔE (unitless) in exterior reflection (the formula for which was indicated above). The overall optical quality of the glass after heat treatment was also evaluated by observing whether defects, localized or otherwise, of the pinhole or haze type appeared.

Next, each of the curved glasses was mounted as laminated glazing by means of a second glass, identically curved but containing no thin layers, and of a sheet of polyvinyl butyral PVB 0.76 mm in thickness, so that the stack was on the 3 face (considering the laminate as a windshield already mounted in the vehicle, numbering the face of the glasses starting from the outermost face in relation to the vehicle.

The glazing was then subjected to the mechanical adhesion test known as the Pummel test, which consists in evaluating the adhesion between the PVB and each of the glass panes (knowing that the presence of the layers at the glass/PVB interface may have a negative impact on the adhesion). This test consists in placing the glass panes in a refrigerated chamber at −20° C. for four hours and then in taking a 500 gram hammer with a hemispherical head and in striking the glass with it as soon as the glass is removed from the refrigerated chamber, the glass being placed on a stand sloping at 45° to the horizontal and installed so that the mid-plane of the glass makes an angle of 5° with the plane of inclination of the stand (the glass is placed on the stand by holding it so that it bears only via its base against the stand). The laminated glazing is struck with the hammer on a line parallel to the base of the glass. The adhesion is then estimated in comparison with specimens once the laminated glazing has been brought again to ambient temperature. The “score” of the glazing is then evaluated as follows:

between 0 and 1, there is no glass/PVB adhesion in the glazing;

between 2 and 3, the adhesion is moderate;

between 4 and 6, the adhesion is optimal; and

above 6, it is too great, this being unsatisfactory in terms of safety.

The results are indicated in Table 4 below for some of the examples.

TABLE 4

| | Optical | Result of | | |
|---|---|---|---|---|
| | quality after | the Pummel | | |
| | heat treatment | test | ΔT_{L} | ΔE |
| Example 1 | Very good | 4 | 4 | 3 |
| | quality | | | |
| Example 2 | Good quality | 4 | 4 | 3 |
| Example 3 | Haze | 4 | 4 | 3 |
| Example 4 | Haze | 1 | >4 | >3 |
| Example 5 | Haze and | 1 | 4 | 3 |
| | pinholes | | | |
| Example 6 | Haze | 1 | 4-5 | 3-4 |
| Example 7 | Good quality | 4 | 4-5 | >4 |

As regards examples 8, 8a, 9 and 9a, their optical quality after bending was also deemed to be satisfactory, examples 8a and 9a being slightly better than examples 8 and 9, respectively. The light transmission T_{L} (again under illuminant D₆₅) values in %, the exterior-side light reflection Rₑₓₜ values, again in %, and the L*, a* and b* values (unitless) in exterior reflection for the laminated glazing using the coated glass panes according to examples 8a and 9a are given in Table 5 below.

TABLE 5

| | EXAMPLE 8a | EXAMPLE 9a |
|---|---|---|
| T_{L} | 77.12 | 75.4 |
| Rₑₓₜ | 30.0 | 32.2 |
| L* | 40.9 | 40.4 |
| a* | −6.02 | −2.3 |
| b* | −2.06 | −5.1 |

In this table, it may be seen that the laminated glazing according to example 8a has a color in exterior reflection in the greens (calorimetric results almost identical to those of example 8 under the same conditions). The laminated glazing according to example 9a is more in the blues in exterior reflection (just like the laminated glazing according to example 9): these two colors are particularly desirable for automobile windshields and side windows. The appearance in exterior reflection of the glazing according to the invention may thus be varied so as to obtain colors that are attractive and/or matched to the color of the bodywork for example (blue, green, blue-green especially). This calorimetric adjustment is accomplished in particular by adjusting the thickness of the dielectric layers, more particularly, in the case of the examples above, the thickness of the silicon-nitride-based layers.

These examples show the importance of the nature of the layers that are in direct contact with the Ag layers: it may be seen that it is more advantageous for the Ti layers to be beneath and not on top of the Ag layers (examples 1 and 2 on the one hand and 3 and 4 on the other) and for them to remain thin, with an advantage in choosing the second layer to be thicker than the first, for the same total Ti thickness (compare examples 1 and 2).

This also confirms the advantage of precisely controlling the stoichiometry of the metal oxide contiguous with the silver layers: overoxidation when depositing the ZnO-based layers on the silver is deleterious from all points of view, as example 5 shows.

Among examples given in Table 4, in terms of optical quality after bending and the result of the Pummel test, examples 1, 2 and 7 are clearly the best.

1. Glazing that comprises at least one transparent substrate S, especially made of glass, provided with a stack of thin layers comprising an alternation of n functional layers A having reflection properties in the infrared and/or in solar radiation, especially metal layers, and of (n+1) coatings B, where n≧1, said coatings B comprising a layer or a superposition of layers made of a dielectric, so that each functional layer A is placed between two coatings B, wherein at least one of the functional layers A is (i) directly in contact with the dielectric coating B placed on top of it and (ii) in contact with the dielectric coating B placed beneath it via a layer C that absorbs at least in the visible, of the metallic, optionally nitride, type.

2. The glazing as claimed in claim 1, wherein:
(i) the or each of the functional layers A is directly in contact with the dielectric coating B placed on top of it, and
(ii) the or each of the functional layers A is in contact with the dielectric coating B placed beneath it via a layer C that absorbs at least in the visible, of the metallic, optionally nitride, type.

3. The glazing as claimed in claim 2, wherein the thickness of the or each of the absorbent layers C is less than or equal to 1 nm, especially less than or equal to 0.7 or 0.6 or 0.5 nm.

4. The glazing as claimed in claim 1, wherein n≧2 and the total thickness of the absorbent layers C is less than or equal to 2.5 nm, especially less than or equal to 2 or to 1.8 or to 1.4 nm.

5. The glazing as claimed in claim 4, wherein the absorbent layers C are placed between the functional layers A and the coatings B which lie beneath them.

6. The glazing as claimed in claim 4, wherein the layer C furthest away from the substrate thicker than the other layers C.

7. The glazing as claimed in claim 1, wherein the absorbent layer or layers are based on titanium, nickel, chromium, niobium, zirconium or a metal alloy containing at least one of these metals.

8. The glazing as claimed in claim 1, wherein that the or each of the functional layers A is based on silver or a silver alloy, especially an alloy of silver with palladium or titanium.

9. The glazing as claimed in claim 1, wherein at least one of the coatings B lying directly on top of a functional layer A starts with a layer D based on one or more metal oxides.

10. The glazing as claimed in claim 1, wherein at least one of the coatings B lying just beneath a functional layer A terminates in a layer D′ based on one or more metal oxides.

11. The glazing as claimed in claim 9, wherein the layer D and/or the layer D′ are based on zinc oxide or on a mixed oxide of zinc and another metal of the Al type.

12. The glazing as claimed in claim 9, wherein the layer D based on one or more metal oxides is deposited so as to be substoichiometric in oxygen, while still remaining below the threshold, beneath which the oxide layer would become absorbent in the visible.

13. The glazing as claimed in claim 9, wherein the layer D based on one or more metal oxides has a thickness of 2 to 30 nm, preferably 5 to 10 nm.

14. The glazing as claimed in claim 10, wherein the layer D′ based on one or more metal oxides has a thickness of 6 to 15 nm.

15. The glazing as claimed in claim 1, wherein in that at least the (n+1)th coating B includes a diffusion barrier layer, especially an oxygen diffusion barrier layer, in particular one based on silicon nitride and/or aluminum nitride.

16. The glazing as claimed in claim 1, wherein in that n≧2 and in that a coating B located between two layers A has a thickness of 50 to 90 nm, including a 0 to 70 nm barrier layer of the silicon nitride and/or aluminum nitride type.

17. The glazing as claimed in claim 15, wherein all the coatings B include a layer based on silicon nitride and/or aluminum nitride.

18. The glazing as claimed in claim 1, wherein the stack comprises the following sequence of layers:
ZnO/Ti/Ag/ZnO
especially with one of the following complete stacks:
Si₃N₄/ZnO/Ti/Ag/ZnO/Si₃N₄/ZnO/Ti/Ag/ZnO/Si₃N₄
ZnO/Ti/Ag/ZnO/Si₃N₄/ZnO/Ti/Ag/ZnO/Si₃N₄
ZnO/Ti/Ag/ZnO/Ti/Ag/ZnO/Si₃N₄
Si₃N₄/ZnO/Ti/Ag/ZnO/Ti/Ag/ZnO/Si₃N₄,
it being possible for the Si₃N₄ and/or ZnO layers to contain an element or a metal, of the Al or boron type, in a minority proportion in relation to Si or to Zn.

19. The glazing as claimed in claim 1, wherein the substrate, once it has been provided with the stack of thin layers, undergoes a heat treatment at above 500° C., of the bending, toughening or annealing type, especially with an average light transmission change ΔT_{L} induced by the heat treatment of at most 5% and/or an average change in the calorimetric response in reflection ΔE* induced by the heat treatment of at most 4.

20. The glazing as claimed in claim 1, wherein the substrate, once it has been provided with the stack of thin layers, undergoes a heat treatment at above 500° C. for the purpose of bending it, with, after bending, a color in exterior reflection in the blues, in the greens or in the blue-greens.

21. The glazing as claimed in claim 1, wherein it is laminated by combining the glass substrate, provided with the stack of thin layers, with another glass substrate via at least one sheet of thermoplastic polymer, or by combining said glass substrate, provided with the multilayer stack, with at least one sheet having energy absorption properties optionally combined with another layer of polymer having self-healing properties, in the form of an asymmetrical laminated glazing.

22. The glazing as claimed in claim 1, wherein it has a colorimetric change at an angle of incidence of 60° characterized by Δa*(0→60)<4 Δb*(0-60)<2 for a*(60°)<0 and b*(60°)<0.

23. The glazing as claimed in claim 1, wherein it is multiple glazing of the double-glazing type.

24. The application of the glazing as claimed in claim 1, as a glazing for automobiles, especially as windshields or side windows, especially with a solar-protection and/or heating and/or de-icing function.
